(19) United States
(12) Patent Application Publication
(10) Pub. No.: US 2024/0424885 A1
(43) Pub. Date: Dec. 26, 2024

(54) HUB-DRIVEN INTEGRATED WHEEL FOR CHILDREN VEHICLE AND ASSEMBLY METHOD OF HUB-DRIVEN INTEGRATED WHEEL

(71) Applicant: Jiaxing Niusida Motor Co., Ltd., Jiaxing (CN)

(72) Inventors: Jianzhong Cai, Jiaxing (CN); Leiyan Cheng, Jiaxing (CN)

(21) Appl. No.: 18/402,268

(22) Filed: Jan. 2, 2024

(30) Foreign Application Priority Data
Jun. 26, 2023 (CN) 202310759898.X

(51) Int. Cl. B60K 7/00; B60B 27/00; B60K 17/04

(52) U.S. Cl. CPC B60K 7/0007; B60B 27/0021; B60K 17/043; B60K 2007/0038; B62D 65/10

(57) ABSTRACT

A hub-driven integrated wheel for a children vehicle and an assembly method thereof are provided. The hub-driven integrated wheel includes a hub, a gearbox installed in the hub, and a tire is arranged on a periphery of an outer side of the hub. The gearbox is clamped to the hub to drive the integrated wheel to move. A limit groove is formed inside an outer side of a gear fixing upper cover along a width direction of the integrated wheel, and a driving motor is assembled in the limit groove. The driving motor is longitudinally assembled in the limit groove, and a driving shaft of the driving motor passes through the gear fixing upper cover and connects to a gear, and the gear is connected to a gear transmission mechanism.

### CROSS-REFERENCE TO RELATED APPLICATION

This patent application claims the benefit and priority of Chinese Patent Application No. 202310759898.X filed with the China National Intellectual Property Administration on Jun. 26, 2023, the disclosure of which is incorporated by reference herein in its entirety as part of the present application.

### TECHNICAL FIELD

The present disclosure belongs to the technical field of children vehicle accessories, and in particular to a hub-driven integrated wheel for a children vehicle and an assembly method of the hub-driven integrated wheel.

### BACKGROUND

Ride-on vehicles for children include two-wheelers, tricycles, four-wheelers, electrically driven vehicles for children, drifting vehicles for children, and the like, all of which are equipped with wheels for ride-on vehicles for children.

In the prior art, the wheel structure of the children vehicle is that rear wheels and the motor are separated, that is, the drive is achieved by accelerating/decelerating the gearbox by the motor. Such a design has the defects that an installation position of the driving system should be considered when designing the wheel structure, and the externally installed drive system occupies the limited space of the vehicle body. Such products are complex, bulk, too heavy, and also has a certain impact on aesthetics.

In order to solve the above technical problems, a hub-driven integrated wheel for a children vehicle is disclosed in the patent No.20202233182.8, which includes a hub, and a fixing mechanism installed inside the hub. A tire is arranged on an outer periphery of the hub, and a gear transmission mechanism and at least one driving motor are assembled on the fixing mechanism. An inner ring gear is arranged on the inner side of the hub in a circumferential direction, and a driving motor drives a gear transmission mechanism (10) to drive the inner ring gear to rotate, thus driving the integrated wheel to move. However, in this scheme, the driving motor is placed horizontally on the gear fixing mechanism, the driving motor will produce great noise when driving the gear transmission mechanism to operate, affecting the use effect of the children vehicle.

It is necessary to improve the problems above.

### SUMMARY

In order to overcome the defects in the prior art, a hub-driven integrated wheel for a children vehicle with a simple structure, reasonable design and capability of reducing the noise and improving aesthetics is provided.

In order to achieve the objective above, a technical solution of the present disclosure is that a hub-driven integrated wheel for a children vehicle includes a hub, and a gearbox installed in the hub. A tire is arranged on an outer periphery of the hub. The gearbox is clamped to the hub to drive the integrated wheel to move. The gearbox includes a gearbox body, the gearbox body includes a gear fixing upper cover, and a gear fixing lower cover. An accommodating cavity is formed between the gear fixing upper cover and the gear fixing lower cover. A gear transmission mechanism is assembled in the accommodating cavity. A limit groove is formed inside an outer side of the gear fixing upper cover along a width direction of the integrated wheel, and a driving motor is assembled in the limit groove. The driving motor is longitudinally assembled in the limit groove, and a driving shaft of the driving motor passes through the gear fixing upper cover and connects to a gear, and the gear is connected to the gear transmission mechanism.

In some embodiments, a motor limiting cover for locating the driving motor is detachably assembled to the outer side of the gear fixing upper cover.

In some embodiments, the hub includes an upper cover and a lower cover which are detachably connected to each other.

In some embodiments, the gear transmission mechanism includes a first gear, a second gear, a third gear, and a driving gear. A first connecting shaft, a second connecting shaft and a third connecting shaft are arranged in the gear fixing upper cover. The first gear movably sleeves the first connecting shaft, the second gear movably sleeves the second connecting shaft, and the third gear movably sleeves the third connecting shaft.

In some embodiments, the first gear includes a first large gear and a first pinion. The first large gear is meshed with the gear. The second gear includes a second large gear and a second pinion. The third gear includes a third large gear and a third pinion. The driving gear includes a connecting gear and a driving member. The first pinion is meshed with the second large gear, the second pinion is meshed with the third large gear, and the third pinion is meshed with the connecting gear.

In some embodiments, a locating cylinder in fit with the driving gear is fixedly arranged on the gear fixing lower cover, and a locating hole is formed in the locating cylinder. The driving member of the third gear passes through and movably sleeves the locating cylinder. A through hole in fit with the driving member is formed in the middle of the gear fixing upper cover, and the driving member of the third gear passes through and is rotatably connected into the through hole.

In some embodiments, a connecting cylinder is fixedly arranged on an outer side of the gear fixing lower cover, the connecting cylinder is an extension portion of the locating cylinder, and the connecting cylinder sleeves a bearing.

In some embodiments, a square through hole is formed in the connecting cylinder, and the square through hole communicates with the locating hole.

In some embodiments, an output clamping portion is fixedly arranged at a position, close to the gearbox, in the middle of the lower cover, the driving member is clamped and in fit with the output clamping portion, so as to drive the integrated wheel to move.

In some embodiments, the output clamping portion includes a clamping ring and a clamping column, and a spacing distance is reserved between the clamping ring and the clamping column. A mounting groove is formed in the middle of the clamping column, and a plurality of grooves are equidistantly formed in a circumferential direction of the clamping column. Correspondingly, multiple bumps (17) corresponding to the grooves are formed on the driving member, and when the driving member is inserted into the mounting groove, the bumps are clamped into the grooves.

An assembly method of a hub-driven integrated wheel for a children vehicle includes the following steps:
Step one: preparing two integrated wheels, and inserting one end of a square pipe into a square through hole of one of the integrated wheels;
Step two: enabling the other end of the square pipe to pass through a vehicle body of the children vehicle to be inserted into a square through hole of another integrated wheel, thus assembling the two integrated wheels together, where locating members are installed on both sides of the vehicle body, and a locating slot in fit with the square pipe is formed in each locating member; and
Step three: clamping the square pipe by locating slots on both sides and the square through holes, so as to complete the assembly of a whole integrated wheel.

The present disclosure has the beneficial effects that:

The present disclosure is simple in structure, convenient and practical, and ingenious in design. By arranging the gearbox, specifically, the gearbox adopts multi-stage speed-changing gears, such that when the driving motor of the children vehicle adopts high power, the gear is stable in transmission, accurate in transmission ratio, high in working reliability, high in transmission efficiency, large in transmission torque, and long in service life. The provided integrated wheel can be directly applied to the existing body structure and shaft of the children vehicle without modification, and the installation is convenient. In addition, the driving motor is longitudinally assembled in the limit groove, and the outer end face of the driving motor is lower than the outer end face of the driving member of the driving gear in the horizontal plane, such that the design of the whole gearbox is more reasonable, and the arrangement of multiple gears in the gear transmission mechanism is more reasonable. Meanwhile, as the driving motor is longitudinally assembled in the limit groove, the noise generated by the driving motor when driving the gear transmission mechanism is reduced, and the use effect of the whole children vehicle is improved.

### BRIEF DESCRIPTION OF THE DRAWINGS

FIG. 1 is a structural schematic diagram of the present disclosure;

FIG. 2 is a structural schematic diagram of a gearbox without a gear fixing lower cover according to the present disclosure;

FIG. 3 is a structural schematic diagram of a lower cover according to the present disclosure;

FIG. 4 is an exploded view of the present disclosure:

FIG. 5 is an exploded view of a gearbox according to the present disclosure;

FIG. 6 is an exploded view of a gear transmission mechanism according to the present disclosure:

FIG. 7 is a structural schematic diagram of a gear fixing lower cover according to the present disclosure:

FIG. 8 is a schematic assembly diagram of an integrated wheel according to the present disclosure;

FIG. 9 is a structural schematic diagram of a locating member according to the present disclosure.

In the drawings: 1 hub; 2 motor limiting cover; 3 tire; 4-gearbox: 5 gear; 6 integrated wheel; 7 square pipe; 8 bearing; 9 vehicle body; 10 gear transmission mechanism; 11 first gear; 11-1 first large gear; 11-2 first pinion; 12 second gear; 12-1 second large gear; 12-2 second pinion; 13 third gear; 13-1 third large gear; 13-2 third pinion; 14 driving gear; 14-1 connecting gear; 14-2 driving member: 15 locating member; 16 locating slot; 17 bump: 20 gearbox body; 21 gear fixing upper cover; 22 first connecting shaft; 23 second connecting shaft; 24 third connecting shaft; 25 driving shaft; 26 through hole; 27 limit groove; 28 positioning cylinder; 28-1 locating hole; 29 gear fixing lower cover; 29-1 connecting cylinder; 29-2 square through hole; 30 accommodating cavity; 31 driving motor; 40 upper cover; 41 lower cover: 46 output clamping portion; 46-1 clamping ring; 46-2 clamping column: 46-3 groove; 46-4 mounting groove.

### DETAILED DESCRIPTION OF THE EMBODIMENTS

The following clearly and completely describes the technical solutions of the present disclosure with reference to the accompanying drawings in the embodiments of the present disclosure. Apparently, the described embodiments are merely a part rather than all of the embodiments of the present disclosure. All other embodiments obtained by a person of ordinary skill in the art based on the embodiments of the present disclosure without creative efforts shall fall within the protection scope of the present disclosure.

In the present disclosure, unless expressly specified and limited otherwise, the terms “install”, “connected” and “connection” should be understood broadly, which, e.g., may be a fixed connection or a detachable connection, or a connection in one piece; may be a mechanical connection or an electrical connection; may be a direct connection or an indirect connection through an intermediate medium, may be an internal communication between the two elements or interactions between the two elements. For those of ordinary skill in the art, the specific meanings of the above terms in the utility model can be understood on a case-by-case basis.

### EMBODIMENT

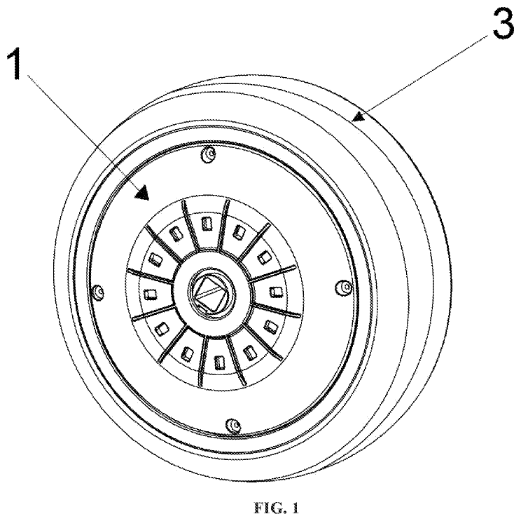

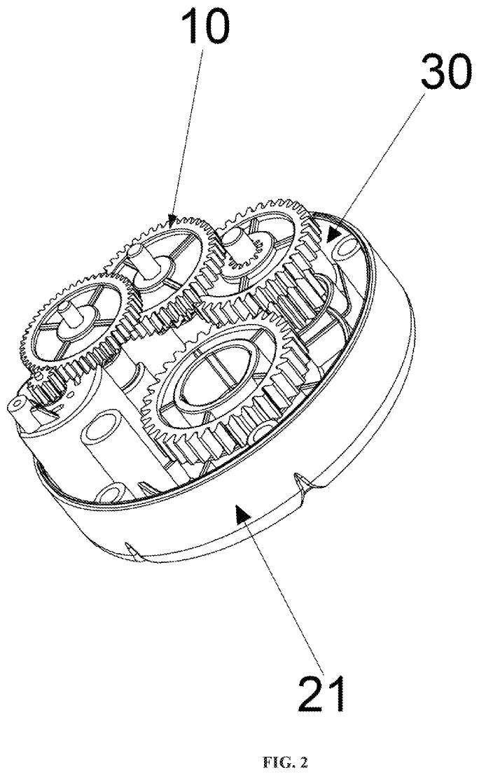

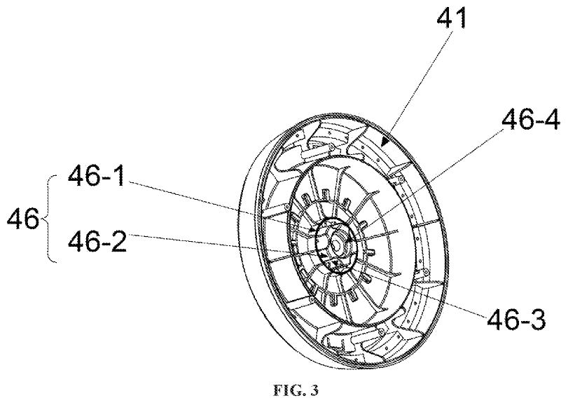

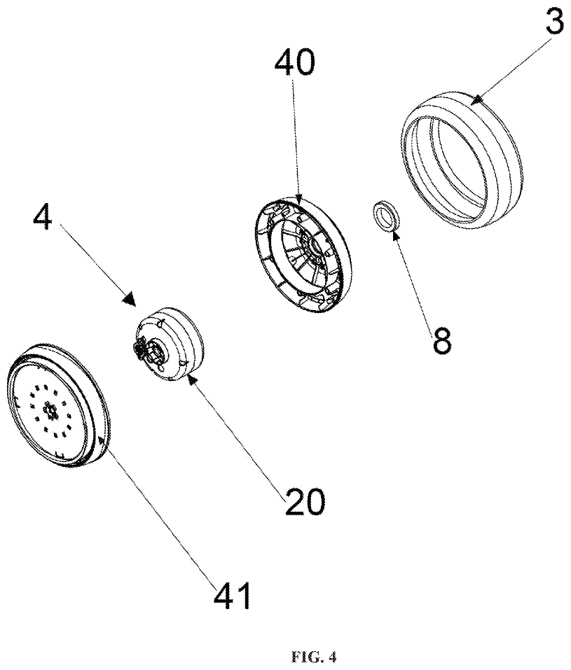

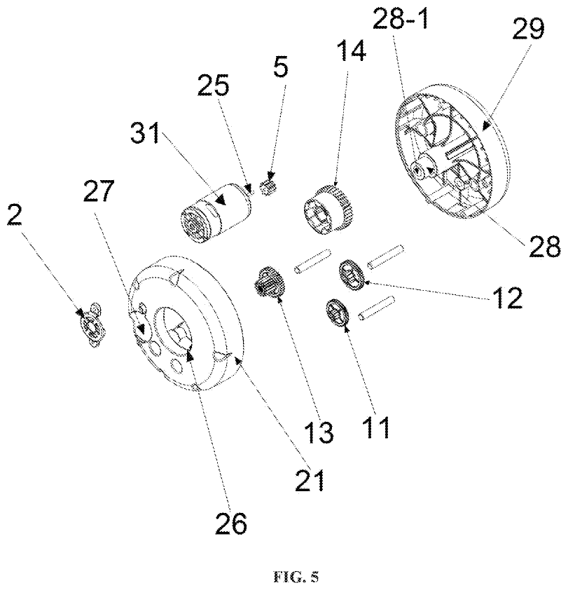

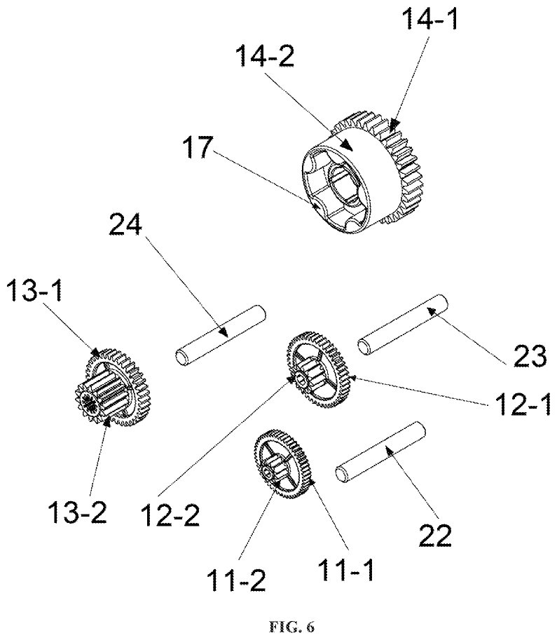

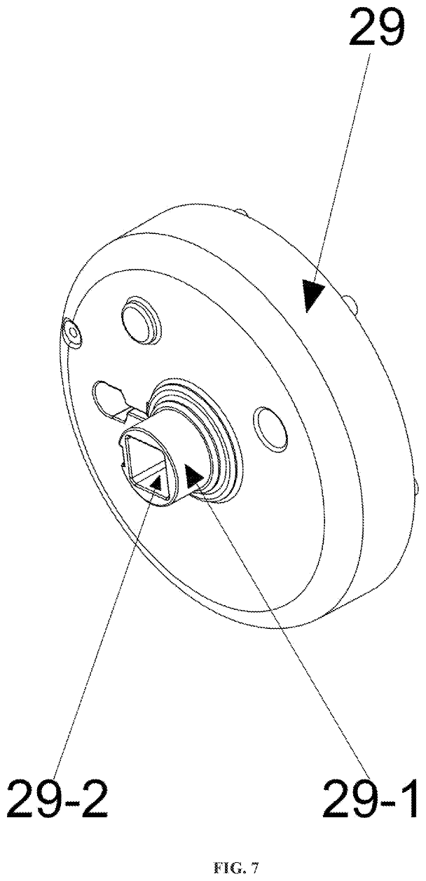

As shown in FIG. 1 through FIG. 7, a hub-driven integrated wheel for a children vehicle is provided according to an embodiment, including a hub 1, and a gearbox 4 installed in the hub 1. A tire 3 is arranged on an outer periphery of the hub 1. The gearbox 4 is clamped to the hub 1 to drive the integrated wheel to move. The gearbox 4 includes a gearbox body 20, the gearbox body 20 includes a gear fixing upper cover 21, and a gear fixing lower cover 29. An accommodating cavity 30 is formed between the gear fixing upper cover 21 and the gear fixing lower cover 29, and a gear transmission mechanism 10 is assembled in the accommodating cavity 30. A limit groove 27 is formed inside an outer side of the gear fixing upper cover 21 along a width direction of the integrated wheel, and a driving motor 31 is assembled in the limit groove 27. The driving motor 31 is longitudinally assembled in the limit groove 27, and a driving shaft 25 of the driving motor 31 passes through the gear fixing upper cover 21 and connects to a gear 5, and the gear 5 is connected to the gear transmission mechanism 10.

The present disclosure is simple in structure, convenient and practical, and ingenious in design. By arranging the gearbox 4, specifically, the gearbox 4 adopts multi-stage speed-changing gears, such that when the driving motor of the children vehicle adopts high power, the gear is stable in transmission, accurate in transmission ratio, high in working reliability, high in transmission efficiency, large in transmission torque, and long in service life. The provided integrated wheel can be directly applied to the existing body structure and shaft of the children vehicle without modification, and the installation is convenient. In addition, the driving motor 31 is longitudinally assembled in the limit groove 27, and the outer end face of the driving motor 31 is lower than the outer end face of the driving member 14-2 of the driving gear 14 in the horizontal plane, such that the design of the whole gearbox is more reasonable, and the arrangement of multiple gears in the gear transmission mechanism 10 is more reasonable. Meanwhile, as the driving motor 31 is longitudinally assembled in the limit groove 27, the noise generated by the driving motor when driving the gear transmission mechanism is reduced, and the use effect of the whole children vehicle is improved.

A motor limiting cover 2 for locating the driving motor 31 is detachably assembled to an outer side of the gear fixing upper cover 21 to facilitate the disassembling of the driving motor 31 and provide convenience for the subsequent maintenance and replacement. Meanwhile, the driving motor 31 is fixed to the gear fixing upper cover 21, so as to guarantee the use safety of the driving motor 31.

The hub 1 includes an upper cover 40 and a lower cover 41, which are detachably connected to each other. The upper cover 40 and the lower cover 41 are fastened via a bolt, thus facilitating maintenance while facilitating the dismounting. According to the integrated wheel provided by the present disclosure, only one integrated wheel body mold needs to be manufactured for the same vehicle, the compatibility of the integrated wheel body is improved, the manufacturing and production period of the mold is shortened, and the production cost of the vehicle is reduced at the same time.

The gearbox according to the present disclosure has the advantages of smaller volume and light weight, is convenient to install and capable of reducing the noise. The gearbox may be suitable for various specifications of tires, and is provided with built-in drive.

The gear transmission mechanism 10 includes a first gear 11, a second gear 12, a third gear 13, and a driving gear 14. A first connecting shaft 22, a second connecting shaft 23 and a third connecting shaft 24 are arranged in the gear fixing upper cover 21. The first gear 11 movably sleeves the first connecting shaft 22, the second gear 12 movably sleeves the second connecting shaft 23, and the third gear 13 movably sleeves the third connecting shaft 24.

According to the present disclosure, the first gear 11 movably sleeves the first connecting shaft 22, the second gear 12 movably sleeves the second connecting shaft 23 and the third gear 13 movably sleeves the third connecting shaft 24, such that the self-weight is reduced, the speed change is light, an external space of the gearbox is saved, and the production requirements are satisfied.

The gear transmission mechanism 10 includes a first gear 11, a second gear 12, a third gear 13, and a driving gear 14. By means of a duplex meshing structure of a gear and a spur gear, an integrated wheel structure is driven by gear meshing and an internal intermediate transmission gear, and thus the gear meshing noise is reduced.

Each of the first gear, the second gear and the third gear in this structure is a small gear, and thus the volume of the gearbox is smaller, and the noise can be reduced. Meanwhile, the combined application of a small motor can reduce an output current, and thus reduce the power consumption.

The first gear 11 includes a first large gear 11-1, and a first pinion 11-2, and the first large gear 11-1 is meshed with the gear 5. The second gear 12 includes a second large gear 12-1, and a second pinion 12-2. The third gear 13 includes a third large gear 13-1, and a third pinion 13-2. The driving gear 14 includes a connecting gear 14-1, and a driving member 14-2. The first pinion 11-2 is meshed with the second large gear 12-1, the second pinion 12-2 is meshed with the third large gear 13-1, and the third pinion 13-2 is meshed with the connecting gear 14-1.

A locating cylinder 28 in fit with the driving gear 14 is fixedly arranged on the gear fixing lower cover 29, and a locating hole 28-1 is formed in the locating cylinder 28. The driving member 14-2 of the third gear 14 passes through and movably sleeves the locating cylinder 28. A through hole 26 in fit with the driving member 14-2 is formed in the middle of the gear fixing upper cover 21, and the driving member 14-2 of the third gear 14 passes through and is rotatably connected into the through hole 26.

A connecting cylinder 29-1 is fixedly arranged on an outer side of the gear fixing lower cover 29. The connecting cylinder 29-1 is an extension portion of the locating cylinder 28, and sleeves a bearing 8. The wear resistance and supporting structure strength of the whole gearbox are improved, the structural strength and overall firmness of the hub are improved, the strength of the hub is significantly improved, and the possibility of shaking during riding is reduced, such that the tire can bear greater shear force and impact force during driving.

A square through hole 29-2 is formed inside the connecting cylinder 29-1, and the square through hole 29-2 communicates with the locating hole 28-1.

An output clamping portion 46 is fixedly arranged at a position, close to the gearbox 4, in the middle of the lower cover 41, and the driving member 14-2 is clamped and in fit with the output clamping portion 46, so as to drive the integrated wheel to move. Specifically, the output clamping portion 46 includes a clamping ring 46-1 and a clamping column 46-2, a spacing distance is reserved between the clamping ring 46-1 and the clamping column 46-2. A mounting groove 46-4 is formed in the middle of the clamping column 46-2, and multiple grooves 46-3 are equidistantly formed in a circumferential direction of the clamping column 46-2. Correspondingly, multiple bumps 17 corresponding to the grooves 46-3 are formed on the driving member 14-2, and when the driving member 14-2 is inserted into the mounting groove 46-4, the bumps 17 are clamped into the grooves 46-3.

The wheel is driven by the gearbox to move. The gear transmission mechanism is installed in the gearbox body, and the driving motor 31 is longitudinally assembled into the limit groove 27, and the overall appearance of the children vehicle after assembly is beautiful, practical and convenient. The cost is low.

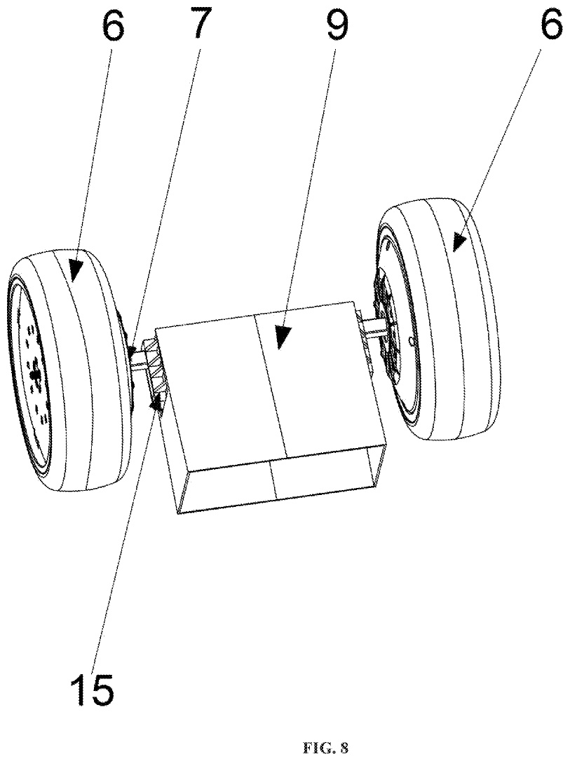

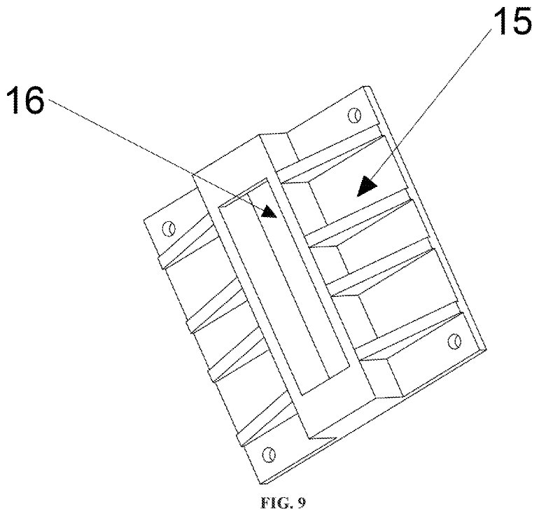

An assembly diagram of an integrated wheel and a structural schematic diagram of a locating member are as shown in FIG. 8 and FIG. 9.

An assembly method of a hub-driven integrated wheel for a children vehicle includes the following steps:

Step one. Two integrated wheels 6 are prepared, and one end of a square pipe 7 is inserted into a square through hole 29-2 of one of the integrated wheels 6.

Step two. The other end of the square pipe 7 is inserted into a square through hole 29-2 of another integrated wheel 6 after passing through a vehicle body 9 of the children vehicle, thus assembling the two integrated wheels 6 together. Locating members 15 are installed on both sides of the vehicle body 9, and a locating slot 16 in fit with the square pipe 7 is formed in each locating member 15.

Step three. The square pipe 7 is clamped by the locating slots 16 on both sides and the square through holes 29-2, so as to complete the assembly of the whole integrated wheel.

The assembly of the whole integrated wheel is simpler, the assembly efficiency is improved, and meanwhile, the use pleasure of the children vehicle is improved, and the service life of the children vehicle is prolonged.

According to the above description of the disclosed embodiments, those skilled in the art can implement or practice the present disclosure. Various modifications to these embodiments are apparent to those skilled in the art, the general principles defined herein may be implemented in other embodiments without departing from the spirit and scope of the present disclosure. Hence, the present disclosure is not limited to the embodiments disclosed herein, but is to conform to the widest scope in accordance with the principles and novel features disclosed herein.

Although reference numerals in the drawings, for example, a hub 1, a motor limiting cover 2, a tire 3, a gearbox 4, a gear 5, an integrated wheel 6, a square pipe 7, a bearing 8, a vehicle body 9, a gear transmission mechanism 10, a first gear 11, a first large gear 11-1, a first pinion 11-2, a second gear 12, a second large gear 12-1, a second pinion 12-2, a third gear 13, a third large gear 13-1, a third pinion 13-2, a driving gear 14, a connecting gear 14-1, a driving member 14-2, a locating member 15, a locating slot 16, a bump 17, a gearbox body 20, a gear fixing upper cover 21, a first connecting shaft 22, a second connecting shaft 23, a third connecting shaft 24, a driving shaft 25, a through hole 26, a limit groove 27, a locating cylinder 28, a locating hole 28-1, a gear fixing lower cover 29, a connecting cylinder 29-1, a square through hole 29-2, an accommodating cavity 30, a driving motor 31, an upper cover 40, a lower cover 41, an output clamping portion 46, a clamping ring 46-1, a clamping column 46-2, a groove 46-3, a mounting groove 46-4, and other terms are used more herein, the possibility of using other terms is not excluded. These terms are merely used for describing and explaining the essence of the present disclosure more conveniently. To construe these terms as any additional limitations is against the spirit of the present disclosure.

What is claimed is:

1. A hub-driven integrated wheel for a children vehicle, comprising a hub (1), and a gearbox (4) installed in the hub (1), wherein a tire (3) is provided on an outer periphery of the hub (1); the gearbox (4) is clamped to the hub (1) to drive the integrated wheel to move; the gearbox (4) comprises a gearbox body (20) including a gear fixing upper cover (21) and a gear fixing lower cover (29), and an accommodating cavity (30) is formed between the gear fixing upper cover (21) and the gear fixing lower cover (29); a gear transmission mechanism (10) is assembled in the accommodating cavity (30); a limit groove (27) is formed inside an outer side of the gear fixing upper cover (21) along a width direction of the integrated wheel, and a driving motor (31) is assembled in the limit groove (27); the driving motor (31) is longitudinally assembled in the limit groove (27), and a driving shaft (25) of the driving motor (31) passes through the gear fixing upper cover and connects to a gear (5), and the gear (5) is connected to the gear transmission mechanism (10).

2. The hub-driven integrated wheel for a children vehicle according to claim 1, wherein a motor limiting cover (2) for locating the driving motor (31) is detachably assembled to the outer side of the gear fixing upper cover (21).

3. The hub-driven integrated wheel for a children vehicle according to claim 1, wherein the hub (1) comprises an upper cover (40) and a lower cover (41) which are detachably connected to each other.

4. The hub-driven integrated wheel for a children vehicle according to claim 1, wherein the gear transmission mechanism (10) comprises a first gear (11), a second gear (12), a third gear (13), and a driving gear (14); a first connecting shaft (22), a second connecting shaft (23) and a third connecting shaft (24) are arranged in the gear fixing upper cover (21); the first gear (11) movably sleeves the first connecting shaft (22), the second gear (12) movably sleeves the second connecting shaft (23), and the third gear (13) movably sleeves the third connecting shaft (24).

5. The hub-driven integrated wheel for a children vehicle according to claim 4, wherein the first gear (11) comprises a first large gear (01-1) and a first pinion (11-2); the first large gear (11-1) is meshed with the gear (5); the second gear (12) comprises a second large gear (12-1) and a second pinion (12-2); the third gear (13) comprises a third large gear (13-1) and a third pinion (13-2); the driving gear (14) comprises a connecting gear (14-1) and a driving member (14-2); the first pinion (11-2) is meshed with the second large gear (12-1), the second pinion (12-2) is meshed with the third large gear (13-1), and the third pinion (13-2) is meshed with the connecting gear (14-1).

6. The hub-driven integrated wheel for a children vehicle according to claim 1, wherein a locating cylinder (28) in fit with the driving gear (14) is fixedly arranged on the gear fixing lower cover (29), a locating hole (28-1) is formed in the locating cylinder (28), the driving member (14-2) of the third gear (14) passes through and movably sleeves the locating cylinder (28); a through hole (26) in fit with the driving member (14-2) is formed in a middle of the gear fixing upper cover (21), and the driving member (14-2) of the third gear (14) passes through and is rotatably connected into the through hole (26).

7. The hub-driven integrated wheel for a children vehicle according to claim 6, wherein a connecting cylinder (29-1) is fixedly arranged on an outer side of the gear fixing lower cover (29), is an extension portion of the locating cylinder (28), and sleeves a bearing (8).

8. The hub-driven integrated wheel for a children vehicle according to claim 7, wherein a square through hole (29-2) is formed inside the connecting cylinder (29-1), and communicates with the locating hole (28-1).

9. The hub-driven integrated wheel for a children vehicle according to claim 3, wherein an output clamping portion (46) is fixedly arranged at a position, close to the gearbox (4), in a middle of the lower cover (41), the driving member (14-2) is clamped and in fit with the output clamping portion (46), so as to drive the integrated wheel to move; the output clamping portion (46) comprises a clamping ring (46-1) and a clamping column (46-2), a spacing distance is reserved between the clamping ring (46-1) and the clamping column (46-2), a mounting groove (46-4) is formed in a middle of the clamping column (46-2), and a plurality of grooves (46-3) are equidistantly formed in a circumferential direction of the clamping column (46-2); and a plurality of bumps (17) corresponding to the plurality of grooves (46-3) are formed on the driving member (14-2), and when the driving member (14-2) is inserted into the mounting groove (46-4), the plurality of bumps (17) are clamped into the plurality of grooves (46-3).

10. An assembly method of the hub-driven integrated wheel for a children vehicle according to claim 1, comprising:
Step one: preparing two integrated wheels (6), and inserting one end of a square pipe (7) into a square through hole (29-2) of one of the integrated wheels (6);
Step two: enabling an other end of the square pipe (7) to pass through a vehicle body (9) of the children vehicle to be inserted into a square through hole (29-2) of another one of the integrated wheels (6), thus assembling the two integrated wheels (6) together, wherein locating members (15) are installed on both sides of the vehicle body (9), and a locating slot (16) in fit with the square pipe (7) is formed in each locating member (15); and
Step three: clamping the square pipe (7) by locating slots (16) on both sides and the square through holes (29-2), so as to complete the assembly of a whole integrated wheel.

11. The assembly method of the hub-driven integrated wheel for a children vehicle according to claim 10, wherein a motor limiting cover (2) for locating the driving motor (31) is detachably assembled to the outer side of the gear fixing upper cover (21).

12. The assembly method of the hub-driven integrated wheel for a children vehicle according to claim 10, wherein the hub (1) comprises an upper cover (40) and a lower cover (41) which are detachably connected to each other.

13. The assembly method of the hub-driven integrated wheel for a children vehicle according to claim 10, wherein the gear transmission mechanism (10) comprises a first gear (11), a second gear (12), a third gear (13), and a driving gear (14); a first connecting shaft (22), a second connecting shaft (23) and a third connecting shaft (24) are arranged in the gear fixing upper cover (21); the first gear (11) movably sleeves the first connecting shaft (22), the second gear (12) movably sleeves the second connecting shaft (23), and the third gear (13) movably sleeves the third connecting shaft (24).

14. The assembly method of the hub-driven integrated wheel for a children vehicle according to claim 13, wherein the first gear (11) comprises a first large gear (11-1) and a first pinion (11-2); the first large gear (11-1) is meshed with the gear (5); the second gear (12) comprises a second large gear (12-1) and a second pinion (12-2); the third gear (13) comprises a third large gear (13-1) and a third pinion (13-2): the driving gear (14) comprises a connecting gear (14-1) and a driving member (14-2): the first pinion (11-2) is meshed with the second large gear (12-1), the second pinion (12-2) is meshed with the third large gear (13-1), and the third pinion (13-2) is meshed with the connecting gear (14-1).

15. The assembly method of the hub-driven integrated wheel for a children vehicle according to claim 10, wherein a locating cylinder (28) in fit with the driving gear (14) is fixedly arranged on the gear fixing lower cover (29), a locating hole (28-1) is formed in the locating cylinder (28), the driving member (14-2) of the third gear (14) passes through and movably sleeves the locating cylinder (28); a through hole (26) in fit with the driving member (14-2) is formed in a middle of the gear fixing upper cover (21), and the driving member (14-2) of the third gear (14) passes through and is rotatably connected into the through hole (26).

16. The assembly method of the hub-driven integrated wheel for a children vehicle according to claim 15, wherein a connecting cylinder (29-1) is fixedly arranged on an outer side of the gear fixing lower cover (29), is an extension portion of the locating cylinder (28), and sleeves a bearing (8).

17. The assembly method of the hub-driven integrated wheel for a children vehicle according to claim 16, wherein a square through hole (29-2) is formed inside the connecting cylinder (29-1), and communicates with the locating hole (28-1).

18. The assembly method of the hub-driven integrated wheel for a children vehicle according to claim 12, wherein an output clamping portion (46) is fixedly arranged at a position, close to the gearbox (4), in a middle of the lower cover (41), the driving member (14-2) is clamped and in fit with the output clamping portion (46), so as to drive the integrated wheel to move; the output clamping portion (46) comprises a clamping ring (46-1) and a clamping column (46-2), a spacing distance is reserved between the clamping ring (46-1) and the clamping column (46-2), a mounting groove (46-4) is formed in a middle of the clamping column (46-2), and a plurality of grooves (46-3) are equidistantly formed in a circumferential direction of the clamping column (46-2); and a plurality of bumps (17) corresponding to the plurality of grooves (46-3) are formed on the driving member (14-2), and when the driving member (14-2) is inserted into the mounting groove (46-4), the plurality of bumps (17) are clamped into the plurality of grooves (46-3).
